(19) United States
(12) Patent Application Publication
(10) Pub. No.: US 2006/0265644 A1
(43) Pub. Date: Nov. 23, 2006

(54) Print processing apparatus, print processing system and print control method

(75) Inventor: Shinji Koizumi, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/134,544

(22) Filed: May 19, 2005

(51) Int. Cl. G06F 17/24

(52) U.S. Cl. 715/522; 715/527

(57) ABSTRACT

In accordance with the embodiment of the present invention, even if the print file stored in a detachable memory or the storage area of a mobile terminal is a file created by application software which cannot be handled by a print processing apparatus, the print file can automatically be transferred to a print processing server in which the print file can be converted into print data and returned to the print processing apparatus, as long as there is such a print processing server which is connected to a network NW and supports the application software, and thereby it is possible to directly print the print file so that the user need not run the process of converting the print file into the print data by himself. In addition, since the print processing apparatus centrally manages the local information of a plurality of servers connected to the network NW, it is possible to quickly perform jobs as viewed from the whole system.

### BACKGROUND OF THE INVENTION

1. Field of the Invention

The present invention relates to a print processing apparatus, a print processing system including a network through which this print processing apparatus is connected to a plurality of servers, and a print control method.

2. Description of the Related Art

Japanese Patent Publication No. 2003-196055 describes a print processing system as described below. This print processing system includes a network through which a server implemented with an application software, client computers and printers are connected, and when the client computer accepts a request to print application data, the print request is transmitted to the server as well as the client information. The server starts a printer driver on the basis of the client information to generate print data, and transmits the print data to the client computer or the printer where print process is performed.

In accordance with this system, all the print data is transmitted to the server through a network in advance, and thus there is a problem that the print process is inefficient.

On the other hand, while there is a system capable of directly printing a file stored in an external storage medium such as a USB flash memory or an SD memory card without the use of a computer, if the print data read from the storage medium is provided in the form of a file which is prepared by an application software which is not supported by the print processing apparatus, the print data cannot be printed. Because of this, conventionally, the print data is converted into print raster image data by connecting the storage medium to a personal computer and the like, and running a printer driver, and transferred to a print processing apparatus or a printer for performing a print process, so that the manipulation is troublesome.

### BRIEF SUMMARY OF THE INVENTION

According to an embodiments of the present invention, it is an object of the present invention to provide a print processing apparatus, a print processing system and a control method thereof which can be used to effectively perform an print operation of data supplied from an external storage medium.

The present invention may provide a print processing system having a print processing apparatus and a plurality of print processing servers connected with each other,

wherein said print processing apparatus is configured to exchange information with a portable storage medium, said print processing apparatus comprising:

(a) a database that is used to centrally manage local information including information about the processing ability of each of said plurality of print processing servers;

(b) a first printer driver that converts a print file created by certain application software in accordance with a data format which can be printed;

(c) a determination unit that determines whether or not said print file can be converted by said first printer driver in accordance with the data format which can be printed when said portable storage medium storing said print file is connected to said print processing apparatus;

(d) a first conversion unit that converts said print file to print data by said first printer driver in accordance with the data format which can be printed when said determination unit determines that said print file can be converted by said first printer driver; and

(e) a print file transmitting unit that, when said determination unit determines that said print file cannot be converted by said first printer driver, selects a print processing server capable of converting said print file in accordance with a data format which can be printed on the basis of the local information managed by said database, and transmits said print file to the print processing server as selected,

each of said plurality of print processing servers comprising:

(f) a print file receiving unit that receives said print file which is transmitted from the print file transmitting unit of said print processing apparatus;

(g) a second conversion unit that includes a second printer driver and converts said print file as received by said print file receiving unit to print data in accordance with a data format which can be printed; and

(h) a transmitting unit that transmits said print data converted by said second signal conversion unit to said print processing apparatus,

wherein said print data converted by said first signal conversion unit or said second signal conversion unit is output to a print engine.

The present invention may provide a print processing apparatus capable of exchanging information with a portable storage medium, and connectable to a plurality of print processing servers, comprising:

a database that is used to centrally manage local information including information about the processing ability of each of said plurality of print processing servers;

a printer driver that converts a print file created by certain application software to print data in accordance with a data format which can be printed;

a print file conversion unit that determines whether or not said print file can be converted to print data by said printer driver in accordance with the data format which can be printed when said portable storage medium storing said print file is connected, that if it is determined that said print file can be converted, converts said print file to the print data by said printer driver in accordance with the data format which can be printed, and that if it is determined that said print file cannot be converted, selects a print processing server capable of converting said print file to print data in accordance with a data format which can be printed on the basis of said local information, transmits said print file to the print processing server as selected, and receives the print data converted by the print processing server as selected in accordance with the data format which can be printed,

wherein said print data as converted in accordance with the data format which can be printed is output to a print engine.

The present invention may provide a print control method for a print processing system having a print processing apparatus and a plurality of print processing servers connected with each other, wherein said print processing apparatus is configured to exchange information with a portable storage medium, said print control method comprising:

a step of managing local information which includes information about the processing ability of each of said plurality of print processing servers;

a determination step of determining, in the case where a print file stored in said portable storage medium is created by certain application section when said portable storage medium storing said print file is connected, whether or not said print file can be converted by a printer driver of said print processing apparatus in accordance with a data format which can be printed;

a conversion step, which is taken if it is determined in said determination step that said print file can be converted in said print processing apparatus, of converting said print file to print data by said printer driver in accordance with the data format which can be printed;

a transmission and reception step, which is taken if it is determined in said determination step that said print file cannot be converted in said print processing apparatus, of selecting a print processing server capable of converting said print file to print data in accordance with a data format which can be printed, transmitting said print file to the print processing server as selected, and receiving the print data converted by said print processing server as selected; and

a print step of printing the print data converted by said conversion step or said transmission and reception step in accordance with a data format which can be printed.

### BRIEF DESCRIPTION OF THE DRAWING

The accompanying drawings, which are incorporated in and constitute a part of the specification, illustrate presently preferred embodiments of the invention.

FIG. 1 is an explanatory view for showing the entire configuration of a print processing system according to the embodiment of the present invention.

FIG. 2 is a block diagram showing the configuration of the print processing apparatus of the print processing system according to the embodiment of the present invention.

FIG. 3 is a block diagram showing the configuration of the print processing server of the print processing system according to the embodiment of the present invention.

FIG. 4 is a flow chart showing the operations of the print processing apparatus according to the embodiment of the present invention.

FIG. 5 is a flow chart showing the operations of the print processing apparatus according to the embodiment of the present invention, as continued from FIG. 4.

### DETAILED DESCRIPTION OF THE INVENTION

Hereinafter, embodiments of the present invention will be explained in detail with reference to the attached drawings.

In this description of the present invention, different types of print data are distinguished by referring to a file (print file) to be printed which is prepared by a particular application software as application print data, referring to data converted by a printer driver in accordance with a printer descriptive language as descriptive data or print data, referring to data converted by a spooler as print raster image data.

The print processing system according to the embodiment of the present invention comprises a print processing apparatus, and a print processing server connected to this print processing apparatus through a network. While it is assumed, in the following explanation, that an MFP (Multi-Function Peripherals) serving as a multifunctional center apparatus is an example of the image forming apparatus, any other appropriate type of a printer can be used as the print processing apparatus. A plurality of print servers are connected to this print processing apparatus through a network, for example, a local area network (LAN).

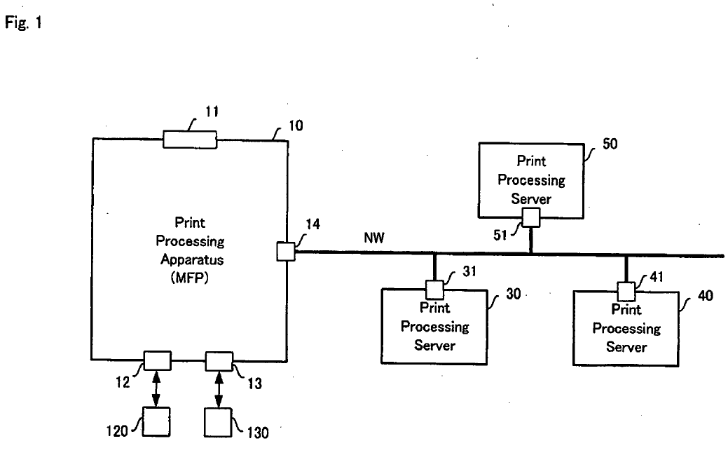

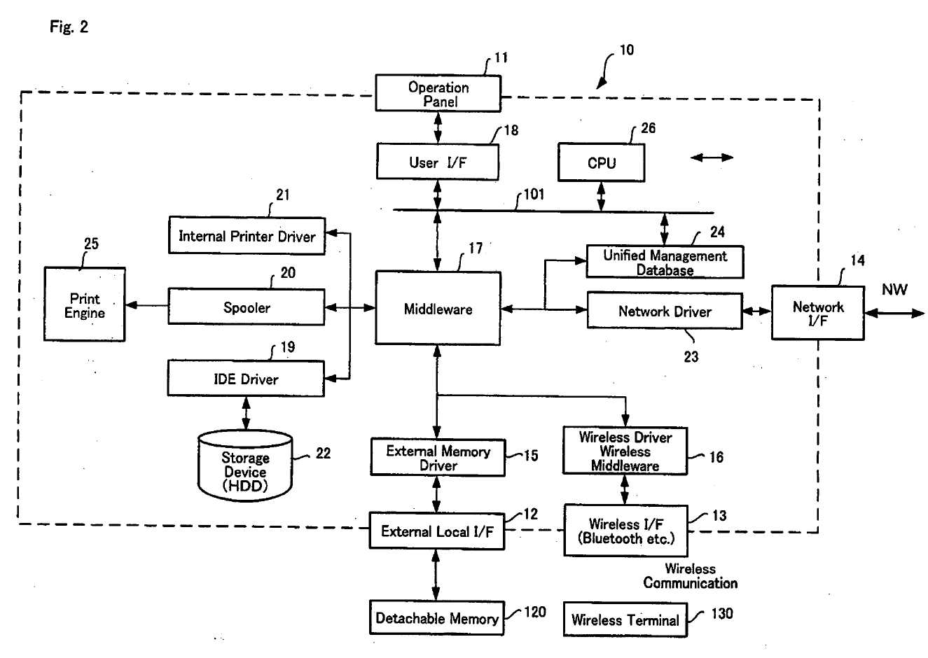

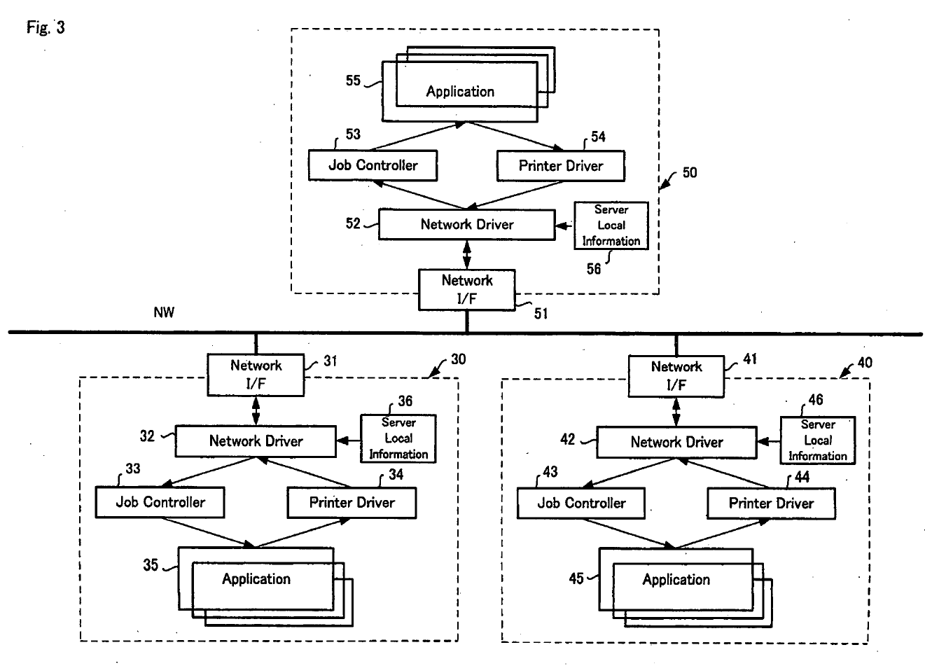

FIG. 1 is an explanatory view for showing the entire configuration of the print processing system according to the embodiment of the present invention; FIG. 2 is a block diagram showing the configuration of the print processing apparatus; and FIG. 3 is a block diagram showing the configuration of the print processing server.

The print processing system as shown in FIG. 1 comprises a print processing apparatus 10, and a plurality of print processing servers 30, 40 and 50 connected to this print processing apparatus through a network NW.

While the print processing apparatus 10 includes a operation panel unit 11, an external local interface (I/F) 12, the wireless interface (I/F) 13 and a network interface (I/F) 14, the print processing servers 30, 40 and 50 include network interfaces (I/F) 31, 41 and 51 respectively, and the print processing apparatus 10 and the print processing servers 30, 40 and 50 are connected to the network NW by the use of the networks I/F 14, 31, 41 and 51.

FIG. 2 shows the specific configuration of the print processing apparatus 10 to which a portable memory 120 such as a USB memory is detachably connected through the external local I/F 12 while the wireless I/F 13 as described above is a Bluetooth interface and the like, in order to enable information exchange with the portable memory 120 or a mobile terminal 130 through the external local I/F 12 or the wireless I/F 13. Incidentally, the portable memory 120 can be a USB flash memory, an SD memory card or the like, and referred to as a detachable memory 120 in the following explanation.

In addition, the print processing apparatus 10 is provided with an external memory driver 15 connected to the external local I/F 12, a wireless driver/wireless middleware 16 connected to the wireless I/F 13, and a middleware 17 connected to the external memory driver 15 and the wireless I/F 13.

The middleware 17 is connected to the operation panel unit 11 through a user interface (I/F) 18, such that an operator can input control signals from the operation panel unit 11 to the middleware 17 by manipulating this operation panel unit 11. The middleware 17 is further connected to an IDE (Integrated device electronics) driver 19, a spooler 20 and an internal printer driver 21.

The IDE driver 19 serves to drive a storage device 22 such as a hard disk drive (HDD), the internal printer driver 21 serves to describe application print data as input from the detachable memory 120 or the mobile terminal 130 in a printer descriptive language, and the spooler 20 serves to convert the print data described in the printer descriptive language into print raster image data which is output to a print engine 25.

The middleware 17 is connected to the network I/F 14 through a network driver 23, and connected to a database 24 for use in centrally managing the local information of the respective servers 30, 40 and 50. In addition, the operation panel unit 11 has manipulation keys, a monitor and an interface to which a mouse can be connected if necessary.

Also, a CPU 26 is connected to the respective blocks of the print processing apparatus 10 through a bus 101 in order to control the overall operation of the print processing apparatus 10.

FIG. 3 shows the configurations of the plurality of print processing servers 30, 40 and 50 connected to the network NW wherein the print processing server 30 includes a network driver 32 connected to the network I/F 31, a job controller 33, a printer driver 34, and an application section 35 in which application software is stored. The other print processing servers 40 and 50 have network drivers 42 and 52, job controllers 43 and 53, printer drivers 44 and 54 and application sections 45 and 55 in the same manner as the print processing server 30.

In addition, the print processing servers 30, 40 and 50 are provided with databases 36, 46 and 56 containing the local information of the respective servers, and serve to manage information, as the local information, about the processing ability of each of the print processing servers 30, 40 and 50 (for example, information about whether or not a print data conversion function is available, information about the file formats which can be converted, and information about the processing capacity for conversion), and in addition to this, information about the busy status of each server and so forth. Also, the unified management database 24 of the print processing apparatus 10 is configured to fetch the local information from the) databases 36, 46 and 56 of the print processing servers 30, 40 and 50 through the network NW, store the local information, and centrally manage the local information.

The network driver 23 of FIG. 2 and the network drivers 32, 42 and 52 of FIG. 3 have functionality of converting data in accordance with a data format which can be used for transmitting data through the network NW, and perform data conversion when transmitting and receiving data.

Next, the overall operation of the print processing system according to the present invention will be explained.

When the detachable memory 120 is connected to the external local I/F 12, the external memory driver 15 detects the detachable memory 120 as connected to start a connection process, and notifies the middleware 17 that the detachable memory 120 is connected. The middleware 17 accesses the detachable memory 120 through the external memory driver 15, and confirms whether or not there is an electronic file in the storage area thereof.

In addition, the middleware 17 notifies the user I/F 18 that a direct printing function is available. When an operator manipulates the operation panel unit 11 to select the direct printing function, the middleware 17 searches the detachable memory 120 for electronic files through the external memory driver 15. In this case, the middleware 17 may automatically start searching the detachable memory 120 for files in subordinate folders, or alternatively may enable an operator to find a desired file to be printed by browsing through the monitor of the operation panel unit 11 in which files are displayed through the user I/F 18.

Also, when the mobile terminal 130 is wireless connected through the wireless I/F 13 by wireless communication, the wireless driver/wireless middleware 16 detects the mobile terminal 130 as connected, and notifies the middleware 17 that the mobile terminal 130 is wireless connected. The middleware 17 accesses the mobile terminal 130 through the wireless driver/wireless middleware 16, and confirms whether or not there is an electronic file in the storage area thereof. In addition, the middleware 17 notifies the user I/F 18 that a direct printing function is available. When an operator manipulates the operation panel unit 11 to select the direct printing function, the middleware 17 searches the storage area of the mobile terminal 130 for electronic files through the wireless driver/wireless middleware 16. In this case, the middleware 17 may automatically start searching the storage area of the mobile terminal 130 for files in subordinate folders, or alternatively may enable an operator to find a desired file to be printed by browsing through the monitor of the operation panel unit 11 in which files are displayed through the user I/F 18.

The file designated as described above to be printed is notified to the middleware 17 through the user I/F 18, and the middleware 17 reads this file from the detachable memory 120 through the external memory driver 15 or reads this file from the storage area of the mobile terminal 130 through the wireless driver/wireless middleware 17.

At this time, the middleware 17 determines whether or not the file can be processed inside the print processing apparatus 10 and, if the file can be processed, it is processed as a print file by the internal printer driver 21. In this case, the storage device 22 such as a HDD may be used to store temporary data in the storage area thereof through the IDE driver 19. The data processed as a print file by the internal printer driver 21 is next processed by the spooler 20 as print data (raster image data) which is then output to the print engine 25.

On the other hand, in the case where the file cannot be handled in the print processing apparatus 10, the middleware 17 transmits the file read from the detachable memory 120 or the storage area of the mobile terminal 130 and the various print settings as received through the user I/F 18 to one of the print processing server 30, 40, 50 . . . , and ask this one print processing server to convert the print data.

Namely, the local information of the databases 36, 46 and 56 of the plurality of servers 30, 40 and 50 connected to the network NW is stored in the unified management database 24 of the print processing apparatus 10, and transmitted to the print processing apparatus 10 in a periodical manner or when necessary, while the print processing apparatus 10 updates the local information of the respective servers when receiving the information. Thus, on the basis of the local information stored in the unified management database 24, the CPU 26 of the print processing apparatus 10 process the file to be converted by selecting a server capable of processing the file format of this file at the highest speed, and controlling the middleware 17 to transfer this file to the server as selected.

The local information as stored contains information about the processing ability of each of the print processing servers 30, 40 and 50 (for example, information about whether or not a print data conversion function is available, information about the file formats which can be converted, and information about the processing capacity for conversion), and in addition to this, information about the busy status of each server and so forth.

The information about the file to be converted and the print settings is transmitted to the job controller 33, 43 or 53 through the network I/F 31, 41 or 51 and the network driver 32, 42 or 52 corresponding to one of the servers 30, 40 and 50 as selected. The job controller 33, 43 or 53 searches the application section 35, 45 or 55 for the application software corresponding to the file as received, and starts the application software.

The job controller 33, 43 or 53 executes a print command of the application software as started, and processes the file as a print file by the printer driver 34, 44 or 54. The print file is returned to the print processing apparatus 10 through the network NW, and processed as print data (raster image data) by the spooler 20, and output to the print engine 60 for printing.

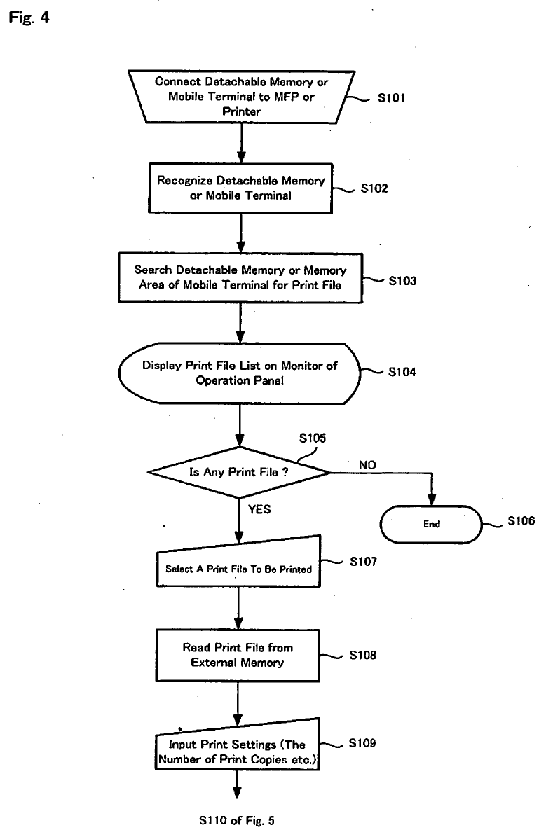

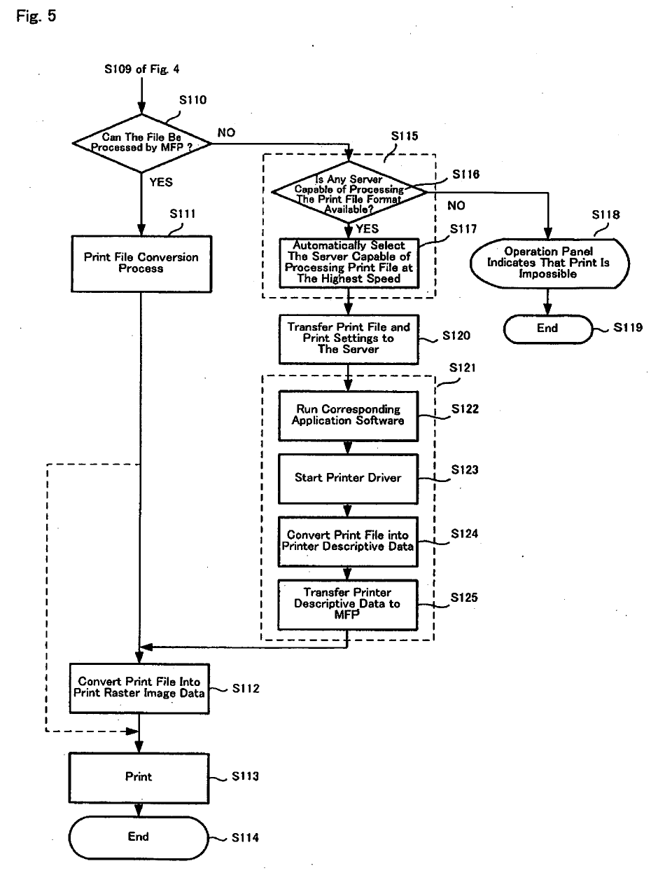

FIG. 4 and FIG. 5 are flow charts showing the operations of the print processing apparatus 10 and the print processing servers 30, 40 and 50.

At first, in step S101 of FIG. 4, the detachable memory 120 is connected to the external local I/F 12 of the print processing apparatus 10. Alternatively, the mobile terminal 130 is connected to the wireless I/F 132 by wireless communication. If the detachable memory 120 or the mobile terminal 130 contains a file to be printed and written by a predetermined application software, the external memory driver 15 or the wireless middleware 17 of the print processing apparatus 10 recognizes the detachable memory 120 or the mobile terminal 130 as connected thereto in step S102.

Furthermore, in the next step S103, the middleware 17 searches the external memory 120 or the storage area of the mobile terminal 130 for print files. Then, in step S104, the search result of printed files is displayed in the monitor of the operation panel unit 11. If there are print file(s), they are displayed, for example, in a file list as the search result. Alternatively, a user may directly designate the location (path) of the file he desired to print. Then, it is determined whether or not there is a print file in step S105 and, if there is no print file, this fact is displayed in the monitor of the operation panel unit 11, followed by terminating the process in step S106.

If there are print file(s) in step S105, the operator selects a file to be printed from the list displayed in the operation panel unit 11 in the next step S107. The operator can select a file to be printed, for example, by moving the cursor of a mouse to the location of the print file in the display screen and clicking the file. The selection by the operator is recognized by the middleware 17 through the user I/F 18.

Incidentally, the operator can designate a file to be printed by directly designating the file through the operation panel unit 11. For example, in the case where the operator exactly knows about the contents of the detachable memory 120, there is an advantage to reduce the time required for designating a file by directly inputting the name of the file without the use of the displayed list. Alternatively, print files can be displayed by a browser in the monitor of the operation panel unit 11 in order to enable the operator to select a file to be printed in the window of this browser.

Next, in step S108, the middleware 17 reads the file to be printed from the detachable memory 120 or the mobile terminal 130, temporarily saves the file in the storage device 22 by starting the IDE driver 19. In step S109, the operation panel unit 11 is manipulated by the operator in order to input various settings for printing, such as the print size of the print file, the number of print copies and so forth, and the process proceeds to step S110 of FIG. 5.

In step S110 of FIG. 5, it is determined by the middleware 17 whether or not the file to be printed can be processed by the print processing apparatus 10 itself. This determination is performed by determining whether or not the internal printer driver 21 of the print processing apparatus 10 serves as the printer driver of the print file. For example, this can be performed by examining the file extension of the print file.

If it is determined that the file can be internally processed in this step S110, the printer driver supporting the file format is read from the internal printer driver 21 in step S111, and used to convert the print file into data (printer descriptive data) in the printer descriptive language suitable for the application software. Next, in step S112, the spooler 20 converts the print file into print raster image data which can be processed by the print engine 60. Thereafter, in step S113, the print raster image data is supplied to the print engine 25 and printed. Incidentally, depending upon the type of the file, the raster image is directly generated in step S111 without conversion into printer descriptive data by skipping step S112 as illustrated in FIG. 5 with a dotted arrow, and the process proceeds to the print process in step S113. The files appropriate for direct raster image conversion include image files which are data compressed such as JPEG files.

On the other hand, if it is determined that the print file as selected cannot be processed by the print processing apparatus 10 itself, the process proceeds from step S110 to step S115 in which a server is selected.

The step 115 comprises step S116 and step S117, and in step S116 the local information of the print processing servers 30, 40 and 50 collected by the print processing apparatus 10 is searched, and the CPU 26 determines whether or not there is a server capable of converting the print file into print data. In the case where the file format cannot be processed even by the print processing servers 30, 40 and 50, it is indicated in the monitor of the operation panel unit 11 that this file cannot be processed in step S118, followed by terminating the process in step S119.

On the other hand, if it is determined in step S116 that the file format can be processed by the print processing servers 30, 40 and 50, the CPU 26 selects in the next step S117 one of the servers 30, 40 and 50 capable of processing the file at the highest speed with reference to the current job scheduling, the performance of the respective servers and so forth on the basis of the local information of the print processing servers 30, 40 and 50 as collected in advance by the unified management database 24 of the print processing apparatus 10, and transfers the print file and the print settings to the server as selected through the network NW (step S120).

The next step S121 is a preparation step of printing operation comprising steps S122 to S125. In step S122, the job controller 33, 43 or 53 provided in the server as selected searches the application section 35, 45 or 55 for the application software capable of handling the image format as transmitted, and starts the application software.

The job controller 33, 43 or 53 executes a print command of the application section 35, 45 or 55 as started, and starts the printer driver 34, 44 or 54 in step S123. In step S124, the print settings of the information as received are automatically reflected in the application software, and the print file is converted into printer descriptive data. In the next step S125, the print file converted by the printer driver 34, 44 or 54 is transferred to the print processing apparatus 10 through the network driver 32, 42 or 52 and the network NW.

Then, the print file as transferred is input to the middleware 17 through the network driver 23 of the print processing apparatus 10, converted into print raster image data by the spooler 20 (step S112), transferred to the print engine 25, and printed by the print engine 25 (step S113).

Incidentally, while the print engine 25 is provided inside the print processing apparatus 10 in the case of the above embodiment of the present invention, the present invention is not limited to this but the print engine can be located outside of the print processing apparatus 10.

In accordance with the present invention, the internal printer driver 21 may include only printer drivers for frequently used application software in the print processing apparatus 10. Also, even if the detachable memory 120 or the storage area of the mobile terminal 130 contains a file which cannot be processed by the print processing apparatus 10, when the server 30, 40 or 50 connected to the network NW supports the application software, the file is automatically transferred to the server which processes the print file into print data and returns the print file to the print processing apparatus 10, so that the user need not run the conversion process into the print data by himself. In addition, since the print processing apparatus 10 centrally manages the local information of the plurality of servers 30, 40 and 50 connected to the network NW, it is possible to quickly perform jobs as viewed from the whole system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the present invention.

What is claimed is:

1. A print processing system having a print processing apparatus and a plurality of print processing servers connected with each other,
wherein said print processing apparatus is configured to exchange information with a portable storage medium, said print processing apparatus comprising:
(a) a database that is used to centrally manage local information including information about the processing ability of each of said plurality of print processing servers;
(b) a first printer driver that converts a print file created by certain application software in accordance with a data format which can be printed;
(c) a determination unit that determines whether or not said print file can be converted by said first printer driver in accordance with the data format which can be printed when said portable storage medium storing said print file is connected to said print processing apparatus;
(d) a first conversion unit that converts said print file to print data by said first printer driver in accordance with the data format which can be printed when said determination unit determines that said print file can be converted by said first printer driver; and
(e) a print file transmitting unit that, when said determination unit determines that said print file cannot be converted by said first printer driver, selects a print processing server capable of converting said print file in accordance with a data format which can be printed on the basis of the local information managed by said database, and transmits said print file to the print processing server as selected,
each of said plurality of print processing servers comprising:
(f) a print file receiving unit that receives said print file which is transmitted from the print file transmitting unit of said print processing apparatus;
(g) a second conversion unit that includes a second printer driver and converts said print file as received by said print file receiving unit to print data in accordance with a data format which can be printed; and
(h) a transmitting unit that transmits said print data converted by said second signal conversion unit to said print processing apparatus,
wherein said print data converted by said first signal conversion unit or said second signal conversion unit is output to a print engine.

2. A system as set forth in claim 1, wherein said print processing apparatus further comprises a manipulation unit having a monitor, displays the information of a print file stored in this storage medium when said portable storage medium is connected and, when an operator selects at least one item of the information as displayed, determines a print file to be printed on the basis of this item of information as selected.

3. A system as set forth in claim 1, wherein said portable storage medium is a portable memory which can be attached to and detached from said print processing apparatus.

4. A system as set forth in claim 1, said portable storage medium is included in a wireless terminal which can wireless communicate with said print processing apparatus.

5. A system as set forth in claim 1, wherein said local information includes information about file formats which can be converted by said plurality of print processing servers and/or information about the processing capacities thereof for conversion, and wherein the local information is transmitted from said plurality of print processing servers to said print processing apparatus at a predetermined timing.

6. A print processing apparatus capable of exchanging information with a portable storage medium, and connectable to a plurality of print processing servers, comprising:
a database that is used to centrally manage local information including information about the processing ability of each of said plurality of print processing servers;
a printer driver that converts a print file created by certain application software to print data in accordance with a data format which can be printed;
a print file conversion unit that determines whether or not said print file can be converted to print data by said printer driver in accordance with the data format which can be printed when said portable storage medium storing said print file is connected, that if it is determined that said print file can be converted, converts said print file to the print data by said printer driver in accordance with the data format which can be printed, and that if it is determined that said print file cannot be converted, selects a print processing server capable of converting said print file to print data in accordance with a data format which can be printed on the basis of said local information, transmits said print file to the print processing server as selected, and receives the print data converted by the print processing server as selected in accordance with the data format which can be printed,
wherein said print data as converted in accordance with the data format which can be printed is output to a print engine.

7. A print processing apparatus as set forth in claim 6, wherein said print processing apparatus further comprises a manipulation unit having a monitor, displays the information of a print file stored in this storage medium when said portable storage medium is connected and, when an operator selects at least one item of the information as displayed, determines a print file to be printed on the basis of this item of information as selected.

8. A print processing apparatus as set forth in claim 6, wherein said portable storage medium is an external memory which can be attached to and detached from said print processing apparatus.

9. A print processing apparatus as set forth in claim 6, said portable storage medium is included in a wireless terminal which can wireless communicate with said print processing apparatus.

10. A print processing apparatus as set forth in claim 6, wherein said local information includes information about file formats which can be converted by said plurality of print processing servers and/or information about the processing capacities thereof for conversion, and wherein this local information is used to select the print processing server to which said print file is to be transmitted.

11. A print processing apparatus as set forth in claim 6, wherein said print file conversion unit comprising:
a determination unit that determines whether or not said print file can be converted to print data by said printer driver in accordance with the data format which can be printed when said portable storage medium storing said print file is connected;
a transmitter receiver unit that selects a print processing server capable of converting said print file to the print data in accordance with a data format which can be printed on the basis of the local information managed by said database, transmits said print file to the print processing server as selected, and receives the print data converted by said print processing server as selected,
wherein the print data converted by said printer driver is input to a printer unit when said determination unit determines that said print file can be converted by said printer driver, the print data converted by said print processing server as selected is output to said printer unit when said determination unit determines that said print file cannot be converted by said printer driver.

12. A print processing apparatus capable of exchanging information with a portable storage medium, and connectable to a plurality of print processing servers, comprising:
a database that is used to centrally manage local information including information about the processing ability of each of said plurality of print processing servers;
a printer driver that converts a print file created by certain application software to print data in accordance with a data format which can be printed;
a determination unit that determines whether or not said print file can be converted to printer descriptive data by said printer driver when said portable storage medium storing said print file is connected;
a conversion unit that converts said print file to said printer descriptive data by said printer driver if it is determined that said print file can be converted by said determination unit;
a transmitter receiver unit that, if it is determined that said print file cannot be converted by said determination unit, selects a print processing server capable of converting said print file to printer descriptive data on the basis of the local information managed by said database, transmits said print file to the print processing server as selected, and receives the print data converted by said print processing server as selected; and
a spooler that converts said printer descriptive data as converted by said printer driver or said printer descriptive data as received by said transmitter receiver unit to print raster image data,
wherein the print raster image data from said spooler is output to a print engine.

13. A print processing apparatus as set forth in claim 12, wherein said determination unit determines whether or not said print file can be converted to printer descriptive data by said printer driver on the basis of the file extension of said print file.

14. A print control method for a print processing system having a print processing apparatus and a plurality of print processing servers connected with each other, wherein said print processing apparatus is configured to exchange information with a portable storage medium, said print control method comprising:
a step of managing local information which includes information about the processing ability of each of said plurality of print processing servers;
a determination step of determining, in the case where a print file stored in said portable storage medium is created by certain application section when said portable storage medium storing said print file is connected, whether or not said print file can be converted by a printer driver of said print processing apparatus in accordance with a data format which can be printed;
a conversion step, which is taken if it is determined in said determination step that said print file can be converted in said print processing apparatus, of converting said print file to print data by said printer driver in accordance with the data format which can be printed;
a transmission and reception step, which is taken if it is determined in said determination step that said print file cannot be converted in said print processing apparatus, of selecting a print processing server capable of converting said print file to print data in accordance with a data format which can be printed, transmitting said print file to the print processing server as selected, and receiving the print data converted by said print processing server as selected; and
a print step of printing the print data converted by said conversion step or said transmission and reception step in accordance with a data format which can be printed.

15. A print control method as set forth in claim 14, wherein said transmission and reception step, which is taken if it is determined in said determination step that said print file cannot be converted in said print processing apparatus, comprising:
a transmission step of selecting a print processing server capable of converting said print file in accordance with a data format which can be printed, and transmitting said print file to the print processing server as selected;
a reception step of converting the print file which is transmitted in said transmission step to print data by said print processing server as selected in accordance with the data format which can be printed, transmitting the print data to said print processing apparatus, and receiving the print data by said print processing apparatus.

16. A print control method as set forth in claim 14, wherein local information including information about file formats which can be converted by said plurality of print processing servers and/or information about the processing capacities thereof for conversion is managed in said managing step.

17. A print control method for a print processing system having a print processing apparatus and a plurality of print processing servers connected with each other, wherein said print processing apparatus is configured to exchange information with a portable storage medium, said print control method comprising:
a step of managing local information including information about the processing ability of each of said plurality of print processing servers;
a determination step of determining, in the case where a print file stored in said portable storage medium is created by certain application section when said portable storage medium storing said print file is connected, whether or not said print file can be converted to printer descriptive data by a printer driver of said print processing apparatus;
a first conversion step, which is taken if it is determined in said determination step that said print file can be converted in said print processing apparatus, of converting said print file to said printer descriptive data by said printer driver;
a transmission step, which is taken if it is determined in said determination step that said print file cannot be converted in said print processing apparatus, of selecting a print processing server capable of converting said print file to printer descriptive data on the basis of said local information, and transmitting said print file to the print processing server as selected;
a second conversion step of converting the print file transmitted in said transmission step to printer descriptive data by the print processing server as selected;
a reception step of transmitting the printer descriptive data converted in said second conversion step from the print processing server as selected to said print processing apparatus, and receiving the printer descriptive data by said print processing apparatus;
a data conversion step of converting the printer descriptive data as converted in said first conversion step or the printer descriptive data as received in said reception step to print raster image data; and
a print step of printing the print raster image data converted in said data conversion step.
